(19) United States
(12) Patent Application Publication
(10) Pub. No.: US 2006/0173658 A1
(43) Pub. Date: Aug. 3, 2006

(54) System and method for numerically exploiting symmetry when using the boundary element method to perform computer-aided engineering

(75) Inventor: Tom Korsmeyer, Wellesley, MA (US)

Correspondence Address: LAHIVE & COCKFIELD, 28 STATE STREET, BOSTON, MA, 02109, US

(73) Assignee: COVENTOR, INC., Cary, NC (US)

(21) Appl. No.: 11/047,322

(22) Filed: Jan. 28, 2005

(51) Int. Cl. G06F 17/10

(52) U.S. Cl. 703/2

(57) ABSTRACT

A method of numerically exploiting symmetry in a coupled electromechanical analysis, while still preserving the previously established advantages of the hybrid BEM/FEM approach for performing such analyses without exploiting symmetry is disclosed. The present invention allows advantageous acceleration techniques, which maximize analytical efficiency, to be employed for the analysis of systems with moving or deformable parts. The illustrative embodiment of the present invention is particularly applicable to simulating the physical behavior of MEMS (microelectromechanical system) devices and other complicated multi-domain devices.

### FIELD OF THE INVENTION

The illustrative embodiment of the present invention relates generally to computer-aided engineering and simulation, and more particularly to a method of simulating the coupled electromechanical behavior of movable or deformable bodies that is useful for simulating the physical behavior of microelectromechanical systems (MEMS).

### BACKGROUND

Computer-aided engineering (CAE) software is used to simulate the behavior of virtual models of realizable devices that may include mechanical and electrical parts, and moving fluids. The predictive power of such software is routinely used in all aspects of engineering design to eliminate, as much as possible, the costly and time consuming process of building and testing physical prototypes. However, performing simulations of virtual models with CAE software can be expensive, since detailed simulation of complex electrical, mechanical, and fluidic behavior often requires high-cost computational hardware and large amounts of memory and processing time to achieve accurate results.

MEMS (microelectromechanical systems) are micro or nano-scale devices typically fabricated in a similar fashion as integrated circuits (ICs) to exploit the miniaturization, integration, and batch processing attainable with semiconductor manufacturing processes. Unlike ICs, which consist solely of electrical components, MEMS devices combine components from multiple physical domains and may contain, for example, electrical, mechanical, and fluidic components. MEMS devices appear in many forms and may include microelectromechanical sensors and actuators such as gyroscopes, accelerometers, and pressure sensors; micro-fluidic devices such as ink jet heads; radio-frequency (RF) devices such as switches, resonators, and passives; and optical devices such as micro-mirrors and fiber alignment devices.

In the simulation of MEMS, one of the most common types of simulation is coupled electromechanical analysis. Such simulations are conducted to understand the mechanical actuation of a device caused by applying a voltage bias between two or more conducting parts; or conversely, to understand the change in capacitance produced by an external force, such as gas pressure, on a movable or deformable part. These coupled electromechanical effects are essential to the functionality of commercially important MEMS, such as inertial sensors, pressure sensors, micromirror-based digital projectors, and radio-frequency switches.

Detailed simulation of electromechanical behavior is an example of a costly and time-consuming computational analysis, because consistent electrostatic and mechanical solutions are found by iteration for any given applied voltage(s). Consequently, considerable research and development effort has been expended in improving the simulation efficiency (accuracy for a given computational time and memory usage). Currently, one of the most effective and commonly used approaches to conducting these analyses is to compute the electrostatic effects using the boundary element method (BEM) and the coupled mechanical effects using the finite element method (FEM). This combined analytic approach is referred to as a hybrid BEM/FEM analysis.

Electrostatic fields and the mechanical behavior of solids are physical phenomena governed by well known partial differential equations and sets of boundary conditions. In mechanics, all of the equations apply only on or within the solid parts. In electrostatics, the boundary conditions apply on the solid surfaces, but the governing equation applies in the space extending infinitely in all directions around the solid parts, which may be either conductors or dielectrics. A consistent and complete set of partial differential equations and boundary conditions is known as a well-posed problem.

Mechanics problems are typically solved numerically using a volumetric approach such as FEM. Briefly, FEM involves breaking the computational volume into discrete pieces (by construction of a volume mesh) and locally applying the continuous differential operator in a discrete form. Through this technique, the problem is reduced to one of solving a sparse system of linear, algebraic equations.

Electrostatics problems, on the other hand, are typically solved using the surface-based BEM approach. A well known mathematical formula, Green's theorem, is used to convert the partial differential equation problem in the volume to an integral equation on the surface of that volume. Then the surface is broken up into discrete pieces (by construction of a surface mesh) with their pair-wise relationships described by an appropriate Green function. In this case, the problem is reduced to solving a dense system of linear, algebraic equations. In recent years, so-called acceleration techniques have been applied to further reduce the dense system of equations to a sparse system, which can be solved more efficiently.

Symmetry is a common feature of electromechanical devices. From the mathematical point of view, the symmetry of a problem may be exploited if the problem is symmetric in both its geometry and its boundary conditions. There may be one, two, or three orthogonal planes of symmetry, or there may be a cyclic symmetry (symmetry in the angle 360/N degrees, for N an integer). When symmetry is present, it may be exploited to reduce the computational cost of a simulation substantially. For the FEM mechanical analysis, exploitation of symmetry involves an application of the symmetry boundary condition requiring that mesh nodes that initially lie on the symmetry plane(s) remain there. For the BEM electrostatic analysis, symmetry requires that the normal derivative of the electric field be zero on the theoretically infinite symmetry plane, if there is a single plane, or the semi-infinite symmetry planes if there are two, etc. There are two ways to enforce the electrostatic boundary condition on the symmetry plane: (1) mathematically, by using a Green function that enforces the condition by construction, as does the addition of the second term to the fundamental Green function in the expression below so that it defines the Green function for electrostatics with symmetry with respect to x=0:

$$G ( \vec{x} , \vec{ξ} ) = \frac{1}{\sqrt{( x - ξ ) + ( y - η ) + ( z - ζ )}} + \frac{1}{\sqrt{( x + ξ ) + ( y - η ) + ( z - ζ )}}$$

or (2) numerically, by constructing a mesh on the symmetry plane to be included in the discrete numerical analysis along with the mesh on the surfaces of the solid parts. The former case automatically takes care of the infinite extent of the plane, while the latter case requires truncation of the mesh on the symmetry plane at some suitable distance from the solid parts such that it appears infinite numerically. (In practice, it has been shown that the mesh on the symmetry plane need not extend far from the parts to achieve converged results.)

It is attractive in the accelerated BEM in use today for electrostatic analysis to use the numerical symmetry plane method, particularly in the case of multiple planes. However, this introduces a requirement to distort, or even re-create the mesh on the symmetry plane during a coupled electromechanical analysis because of the movement or deformation of the solid parts. This is a highly undesirable requirement that is not present in the non-symmetric problem, and would reduce the major attraction of the method, i.e. avoiding the need to separately distort or re-create the mesh in the region outside the parts as they move or deform. The requirement of re-meshing (the term “re-meshing” as used herein includes either or both of the actions of distorting or re-creating the mesh) is triggered because a straightforward application of Green's theorem to the symmetric problem followed by discretization leads to a symmetry plane mesh with no surface elements in the surface regions where parts intersect the symmetry plane. From the Green's theorem point of view, these intersection surfaces are outside the computational domain. Unfortunately, this means that as the parts move or deform, the regions that are the intersections of the parts and the symmetry plane(s) move or distort as well. This necessitates undesirable mesh distortion or re-generation of the mesh on the symmetry plane(s).

### BRIEF SUMMARY

The illustrative embodiment of the present invention provides a method of numerically exploiting symmetry in a coupled electromechanical analyses while still preserving the advantages of the hybrid BEM/FEM approach previously established for non-symmetric problems. The present invention allows advantageous acceleration techniques that maximize analytical efficiency to be employed for the analysis of devices with deformable or moving parts. The illustrative embodiment of the present invention is particularly applicable to the simulation of MEMS (microelectromechanical systems) and other complicated devices that depend on effects from multiple physical domains.

In one embodiment in an electronic device having a simulation environment, a method includes the step of providing at least one numerical symmetry plane for use in a hybrid BEM/FEM (boundary element method/finite element method) coupled electromechanical analysis of a device model. The method also includes the step of meshing at least one part in the device model and at least one area of the numerical symmetry plane that intersects a part in the device model. The mesh on the numerical symmetry plane includes mesh elements in the region where the numerical symmetry plane intersects at least one part in the device model. The method additionally includes the step of determining a boundary-element solution for a field equation for the device model.

In another embodiment in an electronic device having a simulation environment, a method includes the step of providing at least one numerical symmetry plane for use in an analysis of a device model. The method additionally includes the step of meshing at least one part in the device model and at least one area of the numerical symmetry plane that intersects at least one part in the device model. The mesh of the area of the numerical symmetry plane includes the region on the numerical symmetry plane intersecting the part in the device model. The method also determines the results of the analysis of the device model.

In an embodiment, a system in an electronic device with a simulation environment for analyzing a device model includes a coupled electromechanics solver. The coupled electromechanics solver includes a boundary element method (BEM) solver and a finite element method (FEM) solver, the coupled electromechanics solver producing a solver output. The system also includes a mesher that produces an input mesh. The input mesh includes at least one of a numerical symmetry plane mesh, a surface mesh, and a volume mesh, which are utilized by the electromechanics solver. The symmetry plane mesh includes a mesh of at least one area of the symmetry plane which includes a region on the symmetry plane intersecting at least one part in the device model.

### BRIEF DESCRIPTION OF THE DRAWINGS

FIG. 1 shows a schematic of an electronic device having a simulation environment, that is capable of the electromechanical analysis of a device through the creation of a mesh and the consistent solution of the coupled FEM mechanics and BEM electrostatics problems.

FIG. 2 depicts a schematic of the mathematical domain of the single-layer integral-equation formulation of the electrostatics field problem;

FIG. 3 shows a solid model and mesh of a micro-device (a tilting micro-mirror) for which the simulation cost can be reduced by numerically exploiting symmetry;

FIG. 4 shows the solid model and mesh of the device of FIG. 2 after a numerical symmetry plane has been introduced;

FIG. 5A (prior art) shows how the symmetry plane surface mesh would look if an analysis based strictly on Green's theorem were used to numerically exploit symmetry;

FIG. 5B shows how the symmetry plane surface mesh looks after altering the use of Green's theorem as set forth herein for numerically exploiting symmetry.

FIG. 6A (prior art) is a schematic illustrating the effect of the traditional use of Green's theorem for solving an electrostatics problem when a mechanical part is moved;

FIG. 6B is a schematic illustrating the effect of the altered use of Green's theorem for solving an electrostatics problem when a mechanical part is moved;

FIG. 7 depicts the differences between the sequences of steps followed in a hybrid analysis in the traditional usage of Green's theorem and the altered use of Green's theorem described herein;

FIG. 8A depicts the use of one plane of symmetry;

FIG. 8B depicts the use of two orthogonal planes of symmetry; and

FIG. 8C depicts the use of two cyclic symmetry planes.

### DETAILED DESCRIPTION

The illustrative embodiment of the present invention enables the rapid simulation of multi-domain devices such as MEMS. The present invention allows a hybrid BEM/FEM analysis of moving device parts to utilize time saving symmetry principles without requiring multiple episodes of re-meshing of any of the parts or the symmetry plane(s). An altered use of Green's theorem enables parts to move during a simulation without affecting the mesh on the symmetry plane(s) as would conventionally be the case. The present invention is thus particularly applicable to the simulation of MEMS and other multi-domain devices with moving parts.

Numerical PDE solvers take as input a discrete element model that represents the continuous device geometry and some constraints such as boundary conditions or initial conditions. These discrete elements comprise a mesh, and subdivide the large, complicated, geometric shapes of the device into small primitive shapes such as tetrahedra in volumes and triangles on surfaces. The elements are called finite elements if they represent a portion of a 3D solid, or boundary elements if they represent a portion of a surface that encloses a 3D solid. The mesh is made up of points in three-space, called vertices or nodes, and the line segments that connect them, called edges. The elements are collections of nodes and edges, and the device parts are collections of elements.

Numerical PDE solvers, which may be based on the finite element method (FEM), boundary element method (BEM), or a hybrid of the two, are used to obtain detailed, 3D solution fields such as displacement, stress, and electrostatic charge distribution, and integral quantities such as the resonant frequency, damping force, and total capacitance. It should be noted that in both the FEM and BEM solution techniques, discretization of the problem, in other words the construction of volume and/or surface meshes, is required. High quality meshes, meaning meshes that are most conducive to obtaining accurate numerical solutions of integral or partial differential equations, are difficult and computationally costly to construct on complicated geometries. Thus, ideally, the construction of meshes is done only once for the solution of a problem.

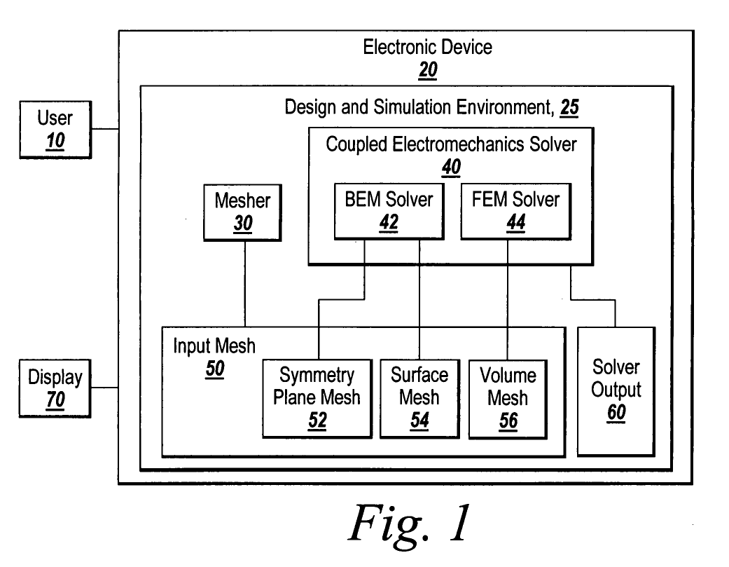

FIG. 1 depicts an environment suitable for practicing the illustrative embodiment of the present invention. A user 10 accesses an electronic device 20. The electronic device 20 includes a simulation environment 25. The electronic device 20 may be a server, workstation, laptop, desktop computer, PDA or other electronic device equipped with a processor and capable of supporting the simulation environment 25. The simulation environment 25, such as COVENTORWARE from Coventor, Inc. of Cary, N.C., is used to model and simulate physically realizable devices, such as MEMS. The simulation environment 25 includes a mesher 30, which is used to create an input mesh 50 of the device. The input mesh 50 may include a symmetry plane mesh 52, a surface mesh 54, a volume mesh 56, or a combination of the different types of meshes. The simulation environment 25 also includes a coupled electromechanics solver 40 which may include a boundary element method (BEM) solver 42 and a finite element method (FEM) solver 44. The boundary element method solver 42 and the finite element method solver 44 are used to perform the hybrid BEM/FEM analysis discussed above on the input mesh 50.

While it has been mentioned that, typically, electrostatic problems are solved by BEM and mechanical problems by FEM, it should be understood that electrostatics problems can be solved by FEM and mechanical problems can similarly be solved by BEM. However, a hybrid BEM/FEM approach as described above, has several advantages that have lead to its widespread use. First, FEM mechanics allows for the solution of nonlinear problems, such as problems with large deformations, which are of practical importance. Many common materials in MEMS devices produce deformable parts. For example MEMS devices include parts made of various forms of silicon, silicon nitride, silicon oxide, and amorphous silicon, parts made from various metals such as gold, aluminum, copper and nickel, and other deformable materials such as glass, quartz and carbon. Secondly, BEM electrostatics uses a surface mesh on the parts, rather than a volume mesh in the space around the parts, with the infinite extent of the problem exactly represented by the Green function. Thirdly, and most importantly, as the parts move or deform, the deformation of the surface and volume mesh is described by the mechanical solution. Regarding the third point, when the parts move or deform in an electromechanical simulation, parts may move arbitrarily close to one another, even to the point of touching. Were the solution technique to involve a computational mesh in the space between the mechanical parts, this mesh would have to be distorted carefully, to continue to cover the changing space between the parts while maintaining the mesh quality. Since this space does not obey any mechanical laws, the distortion of this mesh is not part of the solution and has to be evaluated on geometric considerations alone. This task is nearly as difficult as meshing this space to begin with, if the part movements are large compared to the characteristic part dimensions, as they typically are for MEMS. Moreover, when originally separated parts come into contact, the mesh distortions transform into more difficult topological changes. With the hybrid approach, re-meshing in the volumetric region around the parts is avoided and, when combined with the altered use of Green's theorem of the present invention, re-meshing of numerical symmetry planes is avoided as well. Thus the present invention preserves the computational cost advantages of the hybrid approach when it is extended to exploit problem symmetry.

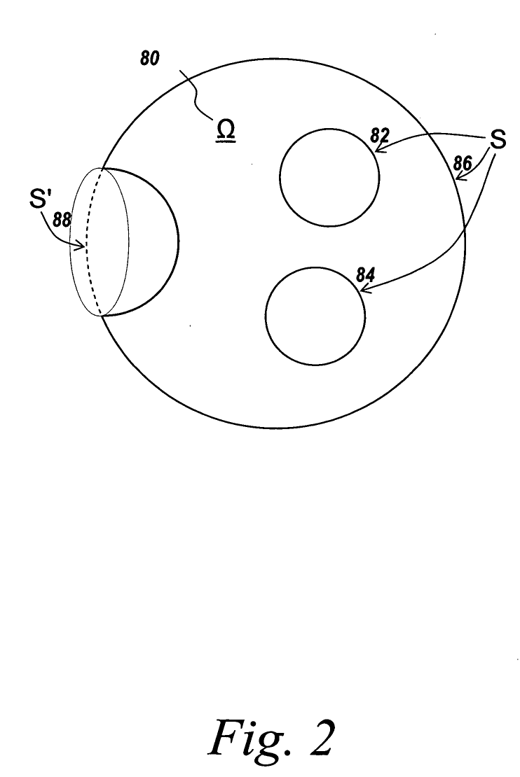

The illustrative embodiment of the present invention provides an alternative to a strict Green's theorem approach to numerically exploiting symmetry. A conventional application of Green's theorem to the device model geometry depicted in FIG. 2 leads to the familiar single-layer formulation of electrostatics:

$$Ψ ( \vec{x} ) = {\int }_{S}^{} \partial S ( \vec{ξ} ) σ ( \vec{ξ} ) G ( \vec{x} , \vec{ξ} )$$

in which Ψ is the potential, σ is the charge density, G is the Green function, and x and ξ are points in three-space within the volumetric region Ω or on the surface S that bounds Ω. This expression may be interpreted as indicating that the potential at any point on S or within Ω is due to the superposition of the influence of the continuous Green function G of strength σ. Note that G is singular in that its value tends to infinity as ξ approaches x. Upon discretization, each of the boundary elements contributes to the potential through its singularity and the representation of the solution is termed a distribution of singularities.

FIG. 2 is a schematic of the mathematical domain of the single-layer integral formulation of electrostatics. The integral equation is valid in the volume Ω 80 and on the surfaces S 82, 84 and 86, which may be device model parts, symmetry planes, or enclosing boundaries. Those skilled in the art will recognize that the specific geometric shapes are not important to the mathematical concepts. Surface S′ 88, unlike surfaces S 82, 84 and 86, does not bound volume Ω 80. It should be noted that although the geometrical shapes are shown here in two dimensions, the definitions are appropriate to the three dimensions of the integral equation.

The altered use of Green's theorem of the present invention rests on the principle that singularities may be introduced into the formulation so long as they do not violate the field equation and they do not violate the boundary conditions. Mathematically, such a construction for a solution is termed an Ansatz. Hence additional singularities may be introduced into the discrete formulation in the form of additional boundary elements, for instance along S′.

With this mathematical justification, the areas of the symmetry plane(s) that intersect the solid bodies are meshed as if the bodies were not present. This marks a major departure from the traditional use of Green's theorem, which holds that singularities are not present at the intersection of the parts in the device model and the symmetry plane. With the present invention, the added singularities are not in the volume of the problem where the field equation is enforced. On these surface elements the symmetry boundary condition is explicitly set, and by the construction of the algebraic system they are forced to satisfy the boundary conditions on the parts of the device. Thus the singularities do not violate either the field equation or the boundary conditions and therefore constitute an Ansatz.

Because the areas of the symmetry plane(s) that intersect the solid parts are meshed as if the parts were not present, moving or deformable parts are now free to slide along the symmetry plane as their motion is dictated by the consistent solution of the electrostatics and mechanics problems. For any given voltage bias and, consequently, any position of the deformable or movable parts, whatever surface elements on the symmetry plane are exposed to the problem domain are there by virtue of Green's theorem and whatever surface elements on the symmetry plane are obscured by the parts are allowed by the Ansatz principle cited above. Accordingly, as the solution proceeds with varying voltage biases, there is no re-meshing required anywhere in the problem, and more precisely none required on any symmetry plane. The lack of the need to distort or re-generate the mesh preserves the virtues of the BEM/FEM approach when numerically exploiting the symmetry of a problem.

It should be noted that since it is considerably easier to construct meshes on the symmetry plane if the regions of intersection between the symmetry plane and the device parts can be disregarded, the altered use of Green's theorem of the present invention is a beneficial approach for numerically exploiting symmetry even for pure electrostatics problems, that is, problems in which the parts are not deforming or moving.

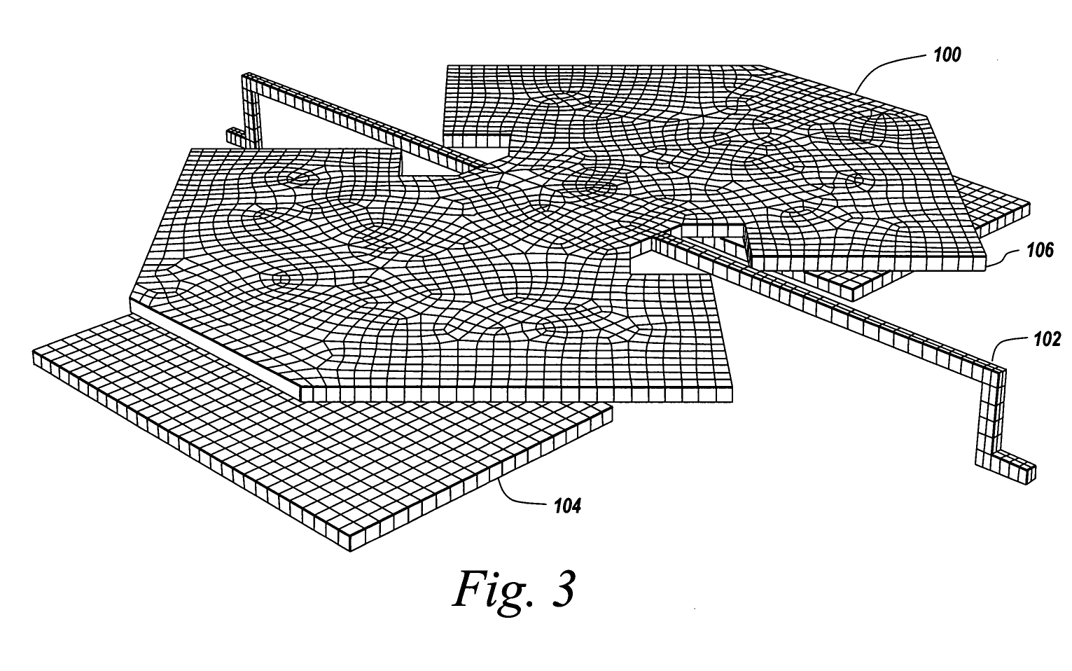

The effect of the alteration in the use of Green's theorem in a hybrid BEM/FEM analysis may be seen in FIGS. 3-7. FIG. 3 shows the model and mesh of a tilting micro-mirror. The micro-mirror 100 is suspended by tethers 102. Actuation electrodes 104 are located beneath the mirror surface. Energizing an electrode causes the mirror to tilt. Upon removal of the voltage bias the mirror returns to the initial position due to the restoring torque in the tethers. The computational mesh 106 on the surface appears as lines drawn on the surface of the mirror 100, tethers 102 and actuation electrodes 104.

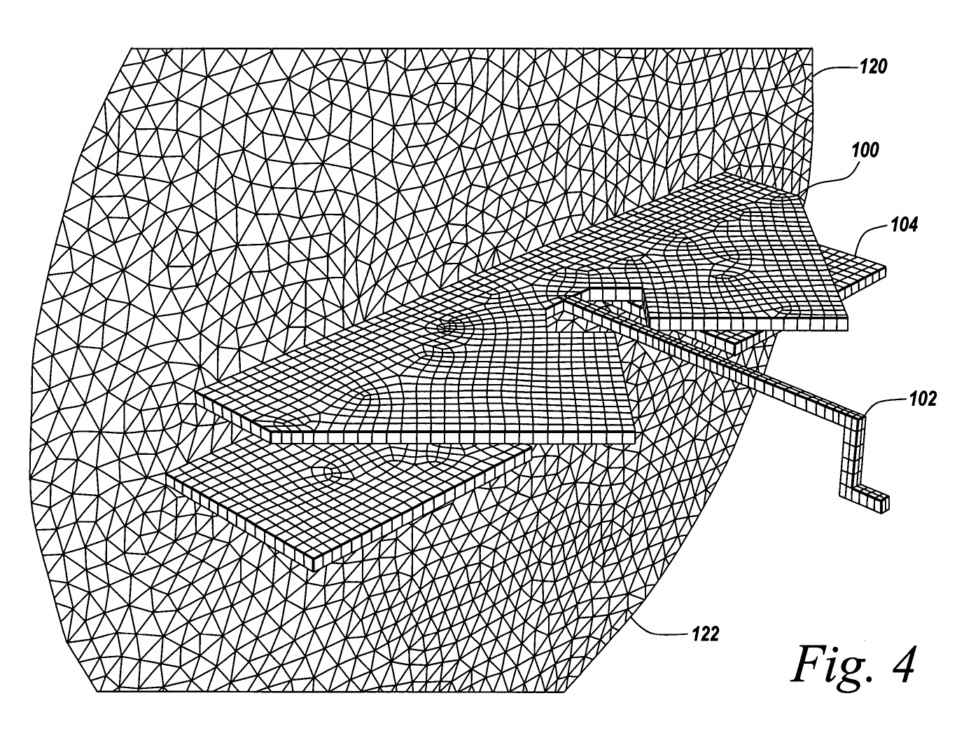

FIG. 4 shows the model and mesh of the device of FIG. 2 after a numerical symmetry plane 120 has been introduced. The surface of the truncated symmetry plane 120 also includes a mesh 122. The tilting micro-mirror of FIG. 3 has been re-meshed so that symmetry can be exploited numerically, by prescribing the symmetry boundary condition on the truncated symmetry plane 120.

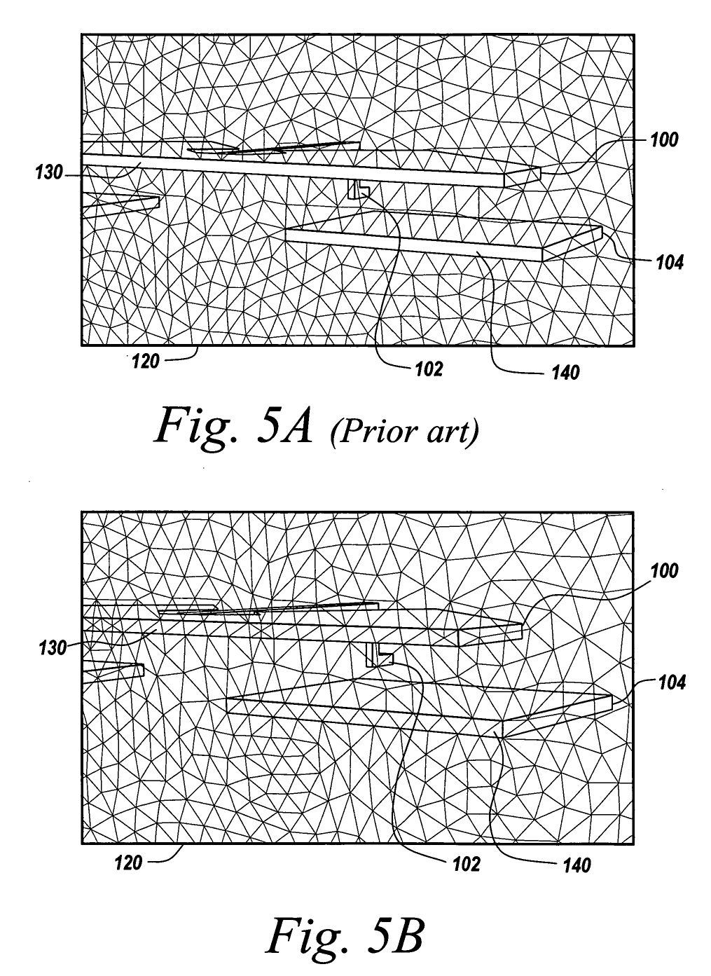

An initial difference in the application of a traditional Green's theorem approach to the simulation of the model and the altered use of Green's theorem as described in the present invention may be seen with reference to FIGS. 5A and 5B. FIG. 5A (prior art) depicts the reverse view of FIG. 4 from the other side of the symmetry plane 120. The micro-mirror 100, and actuators 104 are depicted as being bisected by the symmetry plane 120. The entirety of the surface area of the symmetry plane 120 has been meshed with the exception of the surface areas 130 and 140 representing the area of intersection with the symmetry plane of the solid bodies of the micro-mirror 100 and actuators 104 respectively. This is the result of the traditional application of Green's theorem. As will be discussed further below, it represents a sub-optimal approach for certain types of simulations. FIG. 5B depicts the same reverse view of FIG. 5A except the altered use of Green's theorem has been applied to the hybrid analysis. The entirety of the symmetry plane 120 has been meshed including the surface areas 130 and 140 representing the area of intersection with the symmetry plane of the solid bodies of the micro-mirror 100 and actuators 104 respectively. As will be set forth further below, the present invention utilizes the complete mesh in the analysis of models with moving parts to avoid re-meshing.

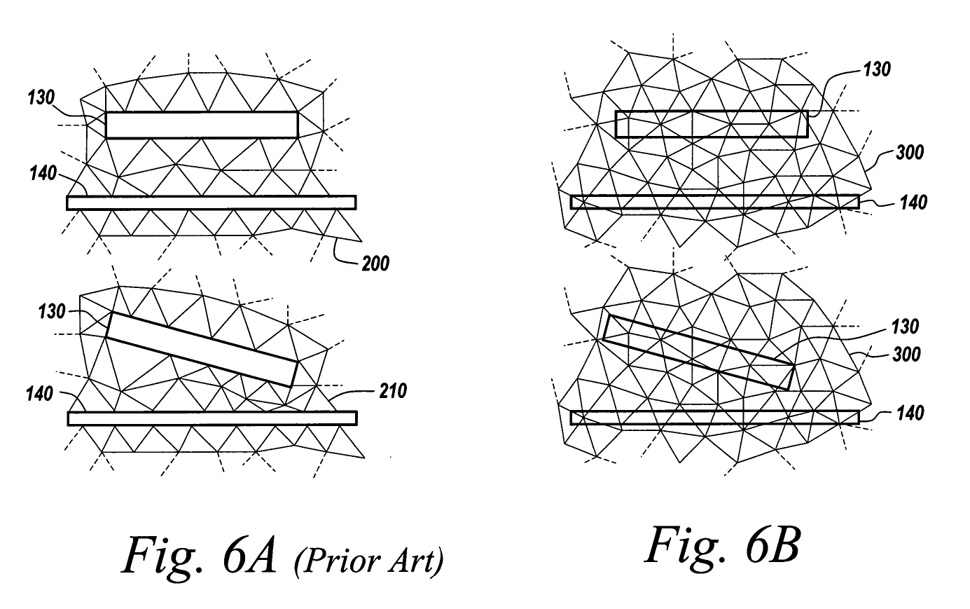

FIG. 6A (prior art) is a schematic illustrating the effect of the traditional use of Green's theorem for an electrostatics problem when a mechanical part is moved. The surface area 130 of the micro-mirror and the surface area 140 of the actuators where they intersect the symmetry plane 120 are shown in an initial position. An initial mesh 200 of the symmetry plane 120 is also depicted. The initial mesh 200 does not include the surface areas 130 and 140. Following the energizing of the actuation electrodes 104, the micro-mirror 100 and, accordingly, the intersecting surface area 130 of the micro-mirror where it intersects the symmetry plane 120, change location. As a result of the movement of the micro-mirror and more specifically the intersecting surface area of the symmetry plane and the micro-mirror, a new mesh 210 of the symmetry plane 120 is required since there is now less space between the bottom right of the mirror and the actuation electrodes and more space between the bottom left of the mirror and the electrodes as depicted. Since the traditional application of Green's theorem indicates that the area of intersection between the solid body and the symmetry plane is not meshed, and the location of intersection area has changed, a new mesh is generated that takes into account the new position of the micro-mirror.

In contrast, FIG. 6B is a schematic illustrating the effect of the altered use of Green's theorem for an electrostatics problem when a mechanical part is moved. The areas of intersection 130 and 140 of the micro-mirror and the actuation electrodes, respectively, with the symmetry plane 120 are shown in an initial position. An initial mesh 300 of the symmetry plane 120 is also depicted. The initial mesh 300 includes the areas of intersection 130 and 140. Following the energizing of the actuation electrodes 104, the micro-mirror 100, and accordingly the intersecting area 130 of the micro-mirror and the symmetry plane 120, change location. However, unlike the situation described above based on the traditional application of Green's theorem, the mesh 300 remains the same. Because the areas of intersection between the solid parts and the symmetry plane do not have to be exempted from the mesh, the mesh on the symmetry plane does not have to be distorted or re-created because of part movement.

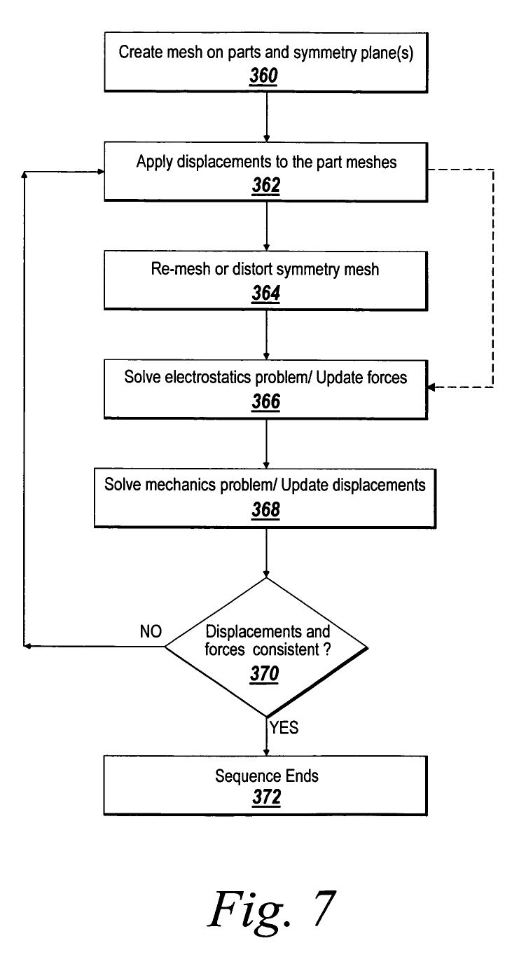

FIG. 7 depicts the differences in the sequences of steps followed in a hybrid FEM/BEM analysis between the traditional usage of Green's theorem and the altered use of Green's theorem described herein. The sequence begins with the creation of mesh on the parts and the symmetry plane or planes (step 360). Any displacement caused as a result of the simulation is then applied to the part meshes (step 362). In the traditional application of Green's theorem, the mesh on the symmetry plane is then distorted or re-created, either of which requires significant calculation (step 364). However, with the altered use of Green's theorem described herein, the re-meshing of the symmetry plane mesh is not performed and this step is skipped. The electrostatic problem is then solved and the force values updated (step 366). The mechanics problem is solved and the displacements are updated (step 368). A determination is then made as to whether the displacements and forces as updated are consistent (step 370). If they are, the sequence ends (step 372). If the updated displacements and forces are not consistent, the displacements are applied to the part meshes (step 362) and the sequence continues.

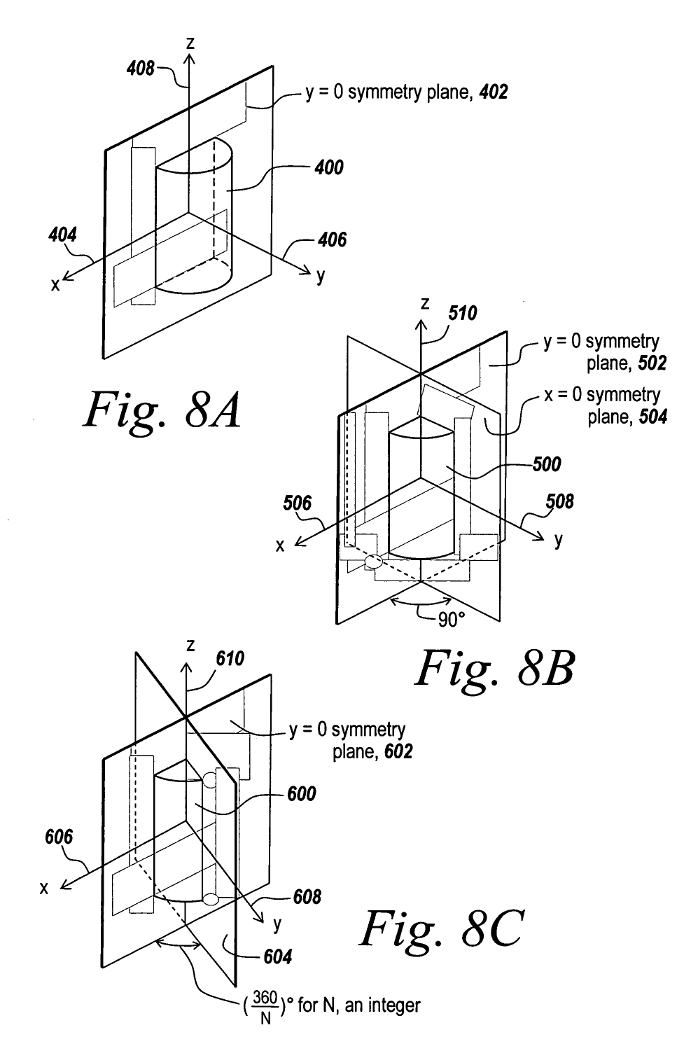

It will be appreciated by those skilled in the art that although the examples contained herein have made reference to a single symmetry plane, two orthogonal, three orthogonal, or cyclic symmetry planes may also be employed within the scope of the present invention. FIGS. 8A-8C depict the use of multiple symmetry planes with the present invention. For illustrative purposes, the device model is represented simply as a cylinder, located with reference to a Cartesian coordinate system (x,y,z). (Those skilled in the art will recognize that in FIGS. 8A-8C the location of the cylinder with its axis coincident with the z-axis and the alignment of the symmetry plane(s) with the principal axes is done for clarity and is otherwise not significant.) FIG. 8A depicts the use of one plane of symmetry. A cylinder 400 is bisected by a symmetry plane 402 at y=0. The x 404, y 406 and z 408 axes are depicted. The problem is said to be symmetric with respect to y=0. FIG. 8B depicts the use of two orthogonal planes of symmetry at y=0 502 and at x=0 504. The x 506, y 508 and z 510 axes are depicted. The problem is said to be symmetric with respect to y=0 and with respect to x=0. It should be noted that for certain device geometries it is also possible to exploit three orthogonal planes of symmetry and such a usage is also within the scope of the present invention. FIG. 8C depicts the use of two cyclic symmetry planes. The two planes 602 and 604 are separated by the angle 360/N degrees where N is an integer. The problem is said to be repetitively symmetric in the angle 360/N degrees. The x 606, y 608 and z 610 axes are depicted. Although the planes of symmetry are depicted as truncated in FIGS. 8A-8C it should be understood that mathematically the symmetry planes are infinite or semi-infinite in extent.

The present invention may be provided as one or more computer-readable programs embodied on or in one or more mediums. The mediums may be a floppy disk, a hard disk, a compact disc, a DVD, a flash memory card, a PROM, a RAM, a ROM, or a magnetic tape. In general, the computer-readable programs may be implemented in any programming language. Some examples of languages that can be used include C, C++, C#, or JAVA. The software programs may be stored on or in one or more mediums as object code.

Since certain changes may be made without departing from the scope of the present invention, it is intended that all matter contained in the above description or shown in the accompanying drawings be interpreted as illustrative and not in a literal sense. Practitioners of the art will realize that the sequence of steps and architectures depicted in the figures may be altered without departing from the scope of the present invention and that the illustrations contained herein are singular examples of a multitude of possible depictions of the present invention.

We claim:

1. In an electronic device having a simulation environment, a method comprising the steps of:
providing at least one numerical symmetry plane for use in a hybrid BEM/FEM (boundary element method/finite element method) coupled electromechanical analysis of a device model;
meshing at least one part in the device model and at least one area of the numerical symmetry plane that intersects at least one part in the device model, the meshing of the at least one area of the numerical symmetry plane including the area of intersection between the numerical symmetry plane and the at least one part in the device model;
determining a boundary-element solution for a field equation for the device model.

2. The method of claim 1 wherein the analysis is a simulation of the device represented by the device model and at least one model part changes location during the simulation.

3. The method of claim 2, comprising the further steps of:
updating the device model; and
determining an updated boundary-element solution for a field equation for the device model without re-meshing the numerical symmetry plane.

4. The method of claim 1, comprising the further step of:
displaying a representation of the device model and the determined solution to a user.

5. The method of claim 1 wherein the device model represents a MEMS (microelectromechanical systems) device.

6. In an electronic device having a simulation environment, a method comprising the steps of:
providing at least one numerical symmetry plane for use in an analysis of a device model;
meshing at least one part in the device model and at least one numerical symmetry plane that intersects at least one part in the device model, the meshing of the at least one numerical symmetry plane including the area of intersection between the at least one numerical symmetry plane and the at least one part in the device model;
determining the results of the analysis.

7. The method of claim 6 wherein the analysis is a simulation of the device represented by the device model and at least one model part changes location during the simulation.

8. The method of claim 7, comprising the further steps of:
updating the device model; and
determining an updated solution for the device model without re-meshing the numerical symmetry plane.

9. The method of claim 6 wherein the analysis of the device model is a pure electrostatic analysis.

10. The method of claim 6 wherein the at least one part is an electrically conducting part.

11. The method of claim 6 wherein the at least one part is a dielectric part.

12. A system in an electronic device with a simulation environment for analyzing a device model, comprising:
a coupled electromechanics solver, the coupled electromechanics solver including a boundary element method (BEM) solver and finite element method (FEM) solver, the coupled electromechanics solver producing a solver output;
a mesher, the mesher producing an input mesh, the input mesh including at least one of a numerical symmetry plane mesh, surface mesh and volume mesh utilized by the electromechanics solver, the symmetry plane mesh including a mesh of at least one area of intersection between the symmetry plane and the at least one part in the device model.

13. The system of claim 12 wherein the device model represents a MEMS (microelectromechanical systems) device.

14. The system of claim 12 wherein the part is an electrically conducting part.

15. The system of claim 12 wherein the part is a dielectric part.

16. The system of claim 12 wherein a numerical symmetry plane mesh, surface mesh and volume mesh are all used by the coupled electromechanics solver to analyze a device model.

17. The system of claim 12 wherein during an analysis of the device model the at least one part moves and the area of intersection between the numerical symmetry plane and the part changes.

18. The system of claim 12 wherein during an analysis of the device model the at least one part deforms and the area of intersection between the numerical symmetry plane and the part changes.

19. The system of claim 12 wherein the analysis of the device model is a pure electrostatic problem without any movement or deformation of a part.

20. The system of claim 12 wherein the analysis is a non-electrostatic problem.

21. In an electronic device having a simulation environment, a medium holding computer-executable instructions for performing a method, the method comprising the steps of:
providing at least one numerical symmetry plane for use in a hybrid BEM/FEM (boundary element method/finite element method) coupled electromechanical analysis of a device model;
meshing at least one part in the device model and at least one area of the numerical symmetry plane that intersects at least one part in the device model, the meshing of the at least one area of the numerical symmetry plane including the area of intersection between the numerical symmetry plane and the at least one part in the device model;
determining a boundary-element solution for a field equation describing physical behavior of a boundary-element solution for a field equation for the device model the device model.

22. The medium of claim 21 wherein the analysis is a simulation of the device model and at least one model part changes location during the simulation.

23. The medium of claim 22, wherein the method comprises the further steps of:
updating the device model; and
determining an updated boundary-element solution for a field equation for the device model without re-meshing the numerical symmetry plane.

24. The medium of claim 21, wherein the method comprises the further step of:
displaying the device model and the analysis to a user.

25. The medium of claim 21 wherein the device model represents a MEMS (microelectromechanical systems) device.

26. In an electronic device having a simulation environment, a medium holding computer-executable instructions for a performing method, the method comprising the steps of:
providing at least one numerical symmetry plane for use in an analysis of a device model;
meshing at least one part in the device model and at least one area of the numerical symmetry plane that intersects at least one part in the device model, the meshing of the at least one area of the numerical symmetry plane including the area of intersection between the numerical symmetry plane and the at least one part in the device model;
determining a solution for a system of field equations representing physical behavior of the device model.

27. The medium of claim 26 wherein the analysis is a simulation of the device model and at least one model part changes location during the simulation.

28. The medium of claim 27, wherein the method comprises the further steps of:
updating the device model; and
determining an updated solution for the device model without re-meshing the numerical symmetry plane.

29. The medium of claim 26 wherein the analysis of the device model is a pure electrostatic problem analysis.

30. The medium of claim 26 wherein the at least one part is an electrically conducting part.

31. The medium of claim 26 wherein the at least one part is a dielectric part.
